(19) United States
(12) Patent Application Publication
(10) Pub. No.: US 2008/0254782 A1
(43) Pub. Date: Oct. 16, 2008

(54) Apparatus, method and computer program product providing inter-operability between legacy and other radio network subsystem

(75) Inventors: Masatoshi Nakamata, Kawasaki-shi (JP); Woonhee Hwang, Espoo (FI); Sami Kekki, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/011,737

(22) Filed: Jan. 29, 2008

Related U.S. Application Data
(60) Provisional application No. 60/898,195, filed on Jan. 29, 2007.

(51) Int. Cl. H04Q 7/20

(52) U.S. Cl. 455/418

(57) ABSTRACT

RNCs are assigned different bit length identifiers, for example 12 bits (legacy) and 16 bits (extended). To enable handovers between adjacent RNCs with different bit length identifiers, several solutions are presented. In a first solution, no logical/direct connection is configured between the adjacent RNCs having different bit length identifiers at least for the case where the value of the longer identifier is not compatible with the shorter identifier. In a second solution, some RNCs are given both a long and a short identifier, and use the one matching the length of the RNC with which a handover occurs. In a third solution, for all adjacent RNCs with an Iur logical connection between them but still having different bit length identifiers, the most significant bits of the longer identifier are not the same as the whole of the shorter bit length identifier. Multiple variations and examples are presented, and implementations include method, apparatus, embodied computer program, and integrated circuit.

### CROSS REFERENCE TO RELATED APPLICATION

This application claims priority to U.S. Provisional Patent Application Ser. No. 60/898,195, filed on Jan. 29, 2007.

### TECHNICAL FIELD

The exemplary and non-limiting embodiments of this invention relate generally to wireless communication systems, methods, devices and computer program products and, more specifically, relate to techniques for inter-operability between radio network entities using different identification number formats (e.g., 12 bit versus 16 bit).

### BACKGROUND

The problem described below, and the examples of the invention detailed herein, are in the context of the Third Generation Partnership Project 3GPP. Specifically, TS 25.413, rel 7.4.0 and also TR 25.999 may be referenced for further definitions and explanations of the various messages and network entities described herein. However, 3GPP implementations are not to be considered a limiting aspect but simply one environment for implementation of this invention.

In the current specification for 3GPP WCDMA Radio Access (wideband code division multiple access), the number of Radio Network Subsystems (RNS) in one network is limited to 4096. This is because in each RNS there is one Radio Network Controller element (RNC) controlling the radio cells (e.g., NodeB's or base stations) of the RNS, and each RNC is uniquely identified by a twelve-bit identifier. Consequently 2¹²=4096 is the maximum number of RNCs that may be in one network. It has been identified in 3GPP that this maximum number of RNSs would not be enough in future adaptations of 3GPP networks, for example because it is anticipated to deploy NodeBs with integrated RNC functionality.

To allow for an increased number of RNCs in a network, the twelve-bit RNC identifier RNC-ID (termed herein a legacy RNC-ID) is extended to sixteen bits so as to increase the maximum number of unique identifiers from 2¹²=4096 to 2¹⁶=65,536. This sixteen-bit identifier is termed herein an extended RNC-ID. A problem arises when there is a changeover between RNCs using these different bit-length identifiers.

Specifically, a problem of compatibility arises when a user equipment UE moves from a RNC operating with a legacy RNC-ID and one operating with an extended RNC-ID, such as during a hard handover HHO, assuming there is no Iur between the two RNCs (an Iur is a logical interface directly between RNCs). Below is considered the specific case for a serving RNC (SRNC) relocation/radio resource control (RRC) connection re-establishment scenario.

FIG. 1 is used to illustrate the problem in two directions. A first RNC 10 controls a first NodeB and a second RNC 20 controls a second NodeB. A UE 30 is moving between those NodeB's, and so changing its SRNC. To illustrate the problem, assume:
no Iur exists between the RNCs;
the first RNC 10 operates with hexadecimal legacy RNC-ID number 001 (1 in decimal); and
the second RNC 20 operates with hexadecimal extended RNC-ID number 2001 (8092 in decimal).

In a first case, the UE 30 is moving from the first (legacy) RNC 10 as source to the second (extended) RNC 20 as target. The source RNC 10 (legacy) treats the RNC-ID of the target RNC 20 (extended) as a twelve-bit identifier, and therefore the RANAP: RELOCATION REQUIRED message that the source RNC 10 sends to the core network CN carries hexadecimal RNC-ID=200 (512 in decimal) as the target RNC for the change (RANAP=Radio Access Network Application Part). The CN may be represented as a Mobile Switching Center MSC or a Serving GPRS Support Node SGSN, for example. The CN then sends the RELOCATION REQUEST message to the RNC bearing the hexadecimal RNC-ID number either 200 (512 decimal) or 2000 (8192 decimal) as being the target RNC. Neither of those RNC-IDs are the correct one for the intended second RNC 20 under whose control the UE 30 is moving.

In a second case, the UE 30 is moving from the second (extended) RNC 20 as source to the first (legacy) RNC 10 as target. The source RNC 20 (extended) treats the RNC-ID of the target RNC 10 (legacy) as a sixteen-bit identifier, and therefore the RANAP: RELOCATION REQUIRED message that the source RNC 20 sends to the core network CN carries hexadecimal RNC-ID=0010 as the target RNC for the change. Note that the last four bits of the RNC-ID are considered to the first four bits of the S-RNTI of a UTRAN/GERAN RNTI received from the UE 30, or the first four bits of the C-ID in a Neighboring Cell Information message received from a drift RNC. The S-RNTI is a radio network temporary identifier RNTI allocated by the SRNC to the UE to identify itself to the SRNC, and is unique within the RNC area. The CN then sends the RELOCATION REQUEST message to the RNC bearing the hexadecimal RNC-ID number 0010 as being the target RNC. Again, this is the incorrect RNC to changeover the UE 30.

The inventors are unaware of any prior art solutions to enable concurrent operation among RNSs using different bit-length identifiers.

### SUMMARY

According to an embodiment of the invention is a method that includes connecting a source controller of a radio network having an identifier of a first length to a core network and connecting a target controller of a radio network having an identifier of a second length to the core network, and supporting relocation of a user equipment from the source controller to the target controller via the connected core network. In this embodiment the core network is adapted to recognize the identifier of the first length and the identifier of the second length.

According to another embodiment of the invention is a computer readable memory embodying a program of machine-readable instructions executable by a digital data processor to perform actions directed toward supporting relocation of a user equipment. In this embodiment the actions include connecting a source controller of a radio network having an identifier of a first length to a core network, connecting a target controller of a radio network having an identifier of a second length to the core network, and supporting at the connected core network relocation of a user equipment between the source controller and the target controller. The core network is adapted to recognize the identifier of the first length and the identifier of the second length.

According to another embodiment of the invention is an apparatus that includes at least one modem and a processor. The at least one modem is configured to connect to a source controller of a radio network having an identifier of a first length and to connect to a target controller of a radio network having an identifier of a second length. The processor is configured to support relocation of a user equipment from the source controller to the target controller and is further adapted to recognize the identifier of the first length and the identifier of the second length.

According to another embodiment of the invention is an apparatus that includes communication means and processing means. The communication means is for connecting to a source controller of a radio having an identifier of a first length and for connecting to a target controller of a radio network having an identifier of a second length. The processing means is for supporting relocation of a user equipment from the source controller to the target controller via the apparatus, and for recognizing the identifier of the first length and the identifier of the second length. IN a particular embodiment, the device of lies within a core network, the source controller is a source radio network controller RNC, the target controller is a target RNC, the communication means includes at least one modem for communicating with the source RNC over a first Iu logical interface and for communicating with the target RNC over a second Iu logical interface, the processing means includes a digital data processor, and supporting relocation includes, in response to receiving over the first Iu logical interface from the source RNC a relocation required message that includes the identifier of the target RNC, sending over the second Iu logical interface to the target RNC a relocation request message.

According to another embodiment of the invention is a method that includes allocating to a first controller of a radio network controller a legacy identifier of a first length and an extended identifier of a second length that is longer than the first length. Further in the method, relocation between the first controller and a second controller of another radio network that has a second identifier of the first length is supported by using the legacy identifier in communications with the second controller related to the relocation that involves the second controller. Further, relocation between the first controller and a third controller that has at least a third identifier of the second length is supported by using the extended identifier in communications with the third controller related to the relocation that involves the third controller.

According to another embodiment of the invention is a computer readable memory embodying a program of machine-readable instructions executable by a digital data processor to perform actions directed toward supporting relocation of a user equipment. In this embodiment the actions include allocating to a first controller of a radio network controller a legacy identifier of a first length and an extended identifier of a second length that is longer than the first length. Further, relocation between the first controller and a second controller of another radio network that has a second identifier of the first length is supported by using the legacy identifier in communications with the second controller related to the relocation that involves the second controller, and relocation between the first controller and a third controller that has at least a third identifier of the second length is supported by using the extended identifier in communications with the third controller related to the relocation that involves the third controller.

According to another embodiment of the invention is an apparatus that includes a memory, a processor and at least one modem. The memory is configured to store an association of a first controller of a radio network controller with a legacy identifier of a first length and with an extended identifier of a second length that is longer than the first length. The processor is coupled to the at least one modem and is configured to support relocation between the first controller and a second controller of another radio network that has a second identifier of the first length by using the legacy identifier in communications with the second controller related to the relocation that involves the second controller. The processor is further configured to support relocation between the first controller and a third controller that has at least a third identifier of the second length by using the extended identifier in communications with the third controller related to the relocation that involves the third controller.

According to another embodiment of the invention is an apparatus that includes storing means, processing means and communication means. The storing means is for storing an association of a first controller of a radio network controller with a legacy identifier of a first length and with an extended identifier of a second length that is longer than the first length. The processing and communication means are for supporting relocation between the first controller and a second controller of another radio network that has a second identifier of the first length by using the legacy identifier in communications with the second controller related to the relocation that involves the second controller, and they are further for supporting relocation between the first controller and a third controller that has at least a third identifier of the second length by using the extended identifier in communications with the third controller related to the relocation that involves the third controller.

According to another embodiment of the invention is a method that includes configuring a radio network such that there is no direct interface between any controller element of the radio network that recognizes only shorter length identifiers for controller elements and any controller element of the radio network that uses a longer length identifier. For the case where one controller element of a pair recognizes only the shorter length identifier and another controller element of the pair uses the longer length identifier, the method continues with thereafter supporting through a core network relocation between the pair of the controller elements.

According to another embodiment of the invention is a computer readable memory embodying a program of machine-readable instructions executable by a digital data processor to perform actions directed toward supporting relocation of a user equipment. In this embodiment the actions include configuring a radio network such that there is no direct interface between any controller element of the radio network that recognizes only shorter length identifiers for controller elements and any controller element of the radio network that uses a longer length identifier. For the case where one controller element of a pair recognizes only the shorter length identifiers and another controller element of the pair uses the longer length identifier, the method continues by thereafter supporting relocation between the pair of the controller elements that use the different length identifiers through a core network.

According to another embodiment of the invention is a system that includes a plurality of at least three radio network controller elements that are configured with respect to one another such that: a) there is no direct interface between any pair of the radio network controller elements for which one controller element of the pair recognizes only shorter length identifiers for controller elements and another controller element of the pair uses a longer length identifier; b) a direct interface exists between each pair of radio network controller elements that are adjacent to one another and that use a same length identifier; and c) a direct interface exists between each of the radio network controller elements and a core network.

According to another embodiment of the invention is a method that includes allocating identifiers to controllers of radio networks such that, for any pair of adjacent controllers having identifiers of different bit lengths and a direct connection between them, the most significant bits of the longer bit length identifier do not repeat the shorter bit length identifier; and supporting relocation between a particular pair of the adjacent controllers using the identifiers of different bit lengths

According to another embodiment of the invention is a computer readable memory embodying a program of machine-readable instructions executable by a digital data processor to perform actions directed toward allocating identifiers in a network. In this embodiment the actions include allocating identifiers to controllers of radio networks such that, for any pair of adjacent controllers having identifiers of different bit lengths and a direct connection between them, the most significant bits of the longer bit length identifier do not repeat the shorter bit length identifier.

According to another embodiment of the invention is a system that includes a plurality of radio network controllers each having an assigned identifier for use in relocation procedures, the radio network controllers configured such that there is a direct connection between some pairs of adjacent radio network controllers and there is no direct connection between other pairs of adjacent radio network controllers. For each of the other pairs of adjacent radio network controllers that also have different bit length identifiers assigned, the most significant bits of the longer bit length identifier of the pair does not repeat the shorter bit length identifier of the pair.

According to another embodiment of the invention is an apparatus that includes a processor and a memory that are configured to allocate identifiers to controllers of radio networks such that, for any pair of adjacent controllers having identifiers of different bit lengths and a direct connection between them, the most significant bits of the longer bit length identifier do not repeat the shorter bit length identifier. The processor and memory are also configured to support relocation between a particular pair of the adjacent controllers using the identifiers of different bit lengths.

According to another embodiment of the invention is an apparatus that includes processing means and storing means. The processing means is for allocating identifiers to controllers of radio networks such that, for any pair of adjacent controllers having identifiers of different bit lengths and a direct connection between them, the most significant bits of the longer bit length identifier do not repeat the shorter bit length identifier. The storing means is for storing in a local memory the allocated identifiers. In a particular embodiment, the processing means is a digital controller and the storing means is a computer memory readable by the digital controller.

These and other aspects are detailed more particularly below. It is noted that the various aspects may be combined in whole or in part with one another according to these teachings.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 is a schematic block diagram of radio network controllers grouped according to their RNC-ID format, to illustrate the various implementations detailed herein.

FIG. 3 is a signaling diagram in accordance with one example of the invention where the target RNC uses only a legacy ID number.

FIG. 4 is a signaling diagram in accordance with one example of the invention where the target RNC uses both a legacy ID number and an extended ID number, showing two different situations by which a UE handover is initiated.

FIG. 5 is a signaling diagram in accordance with one example of the invention where the SRNC uses only an extended ID number and the target RNC uses only a legacy ID number.

FIG. 6 is a signaling diagram in accordance with one example of the invention where the SRNC uses only a legacy ID number and the target RNC uses both a legacy ID number and an extended ID number.

FIG. 7 is a signaling diagram in accordance with one example of the invention where the SRNC and a drift RNC use only legacy ID numbers and the target RNC uses both a legacy ID number and an extended ID number.

FIG. 8 is a signaling diagram in accordance with one example of the invention where there is no Iur between source and target RNCs, and a drift RNC is employed.

FIG. 9 is a process flow diagram according to one aspect of the invention.

FIG. 10 is a process flow diagram according to another aspect of the invention.

FIG. 11 is a process flow diagram according to still another aspect of the invention.

FIG. 12 is a process flow diagram according to yet another aspect of the invention.

### DETAILED DESCRIPTION

The following description details multiple embodiments that enable interoperability among RNCs using different bit-length identifiers, or more generally identifiers of different format. As noted above, the description below is in the context of 3GPP WCDMA, and the described embodiments are seen as particularly advantageous when the RNC-ID formats at issue are of different bit-length. However, it will be appreciated that at least some of the embodiments described herein can be used to enable interoperability where the bit difference between identifiers is other than the twelve-to-sixteen disparity described by example, or when the difference between identifier format is some other quality other than bit-length.

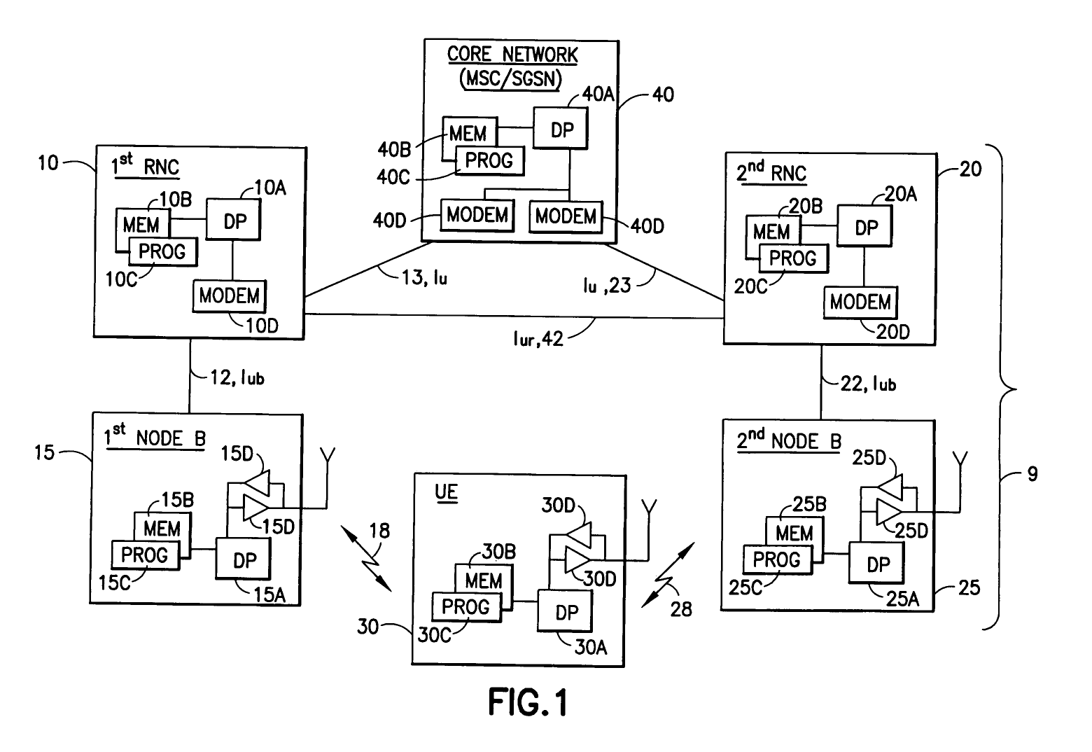

Prior to detailing such embodiments, reference is made first to FIG. 1 for illustrating a simplified block diagram of various electronic devices that are suitable for use in practicing the exemplary embodiments of this invention. In FIG. 1 a wireless network 9 is adapted for communication with a UE 30 via a first NodeB 15 over a first wireless link 18, and also via a second NodeB 25 over a second wireless link 28. The wireless links 18, 28 are generally active only at different times. While only one is shown for each, either or both of the RNCs may control multiple NodeBs. The NodeB's may be E-NodeB's (Evolved NodeBs) as contemplated under E-UTRAN. The network 9 includes a first RNC 10 that controls the first NodeB 15 through a first Iub interface 12, and a second RNC 20 that controls the second NodeB 25 through a second Iub interface 22. Each of these Iub interfaces 12, 22 may be wired or wireless, and relay nodes may also be present between either of the NodeBs and the UE, such as where the network 9 is a mesh network with fixed and/or mobile relay nodes (not shown). The first RNC 10 is coupled to a core network CN 40 (such as a mobile switching center MSC or a Serving GPRS Support Node SGSN) through a first Iu interface 13, and similarly the second RNC 20 is coupled to the CN 40′ via a second Iu interface 23. The RNCs 10, 20 are coupled to one another through an Iur interface 42.

Each of the RNCs 10 & 20 includes a data processor (DP) 10A & 20A, a memory (MEM) 10B & 20B that stores a program (PROG) 10C & 20C, and a modem 10D & 20D for modulating and demodulating messages sent and received over the various bidirectional interfaces. Similarly, each of the NodeBs 15 & 25 include a DP 15A & 25A and a MEM 15B & 25B that stores a PROG 15C & 25C. The NodeB's 15 & 25 each also include a modem for communicating with their respective RNC 10 & 20 over the Iub, but in FIG. 1 is shown only a suitable radiofrequency RF transceiver 15D & 25D for wireless bidirectional communication at a suitable RF, such as with the UE 30 over the links 18 & 28. The UE 30 also includes a DP 30A, a MEM 30B for storing a PROG 30C, and a wireless transceiver 30D. Further, the CN 40 also includes a DP 40A, a MEM 40B that stores a RPOG 40C and one or more modems 40D (two shown) for communicating with the first RNC 10 and the second RNC 20 over the Iu interfaces 13,23. At least the PROGs 10C, 20C & 40C, and in some embodiments also 15C, 25C and/or 30C, are assumed to include program instructions that, when executed by the associated DP, enable the electronic device to operate in accordance with the exemplary embodiments of this invention, as will be discussed below in greater detail.

Certain of the exemplary embodiments of this invention may be implemented at least in part by computer software executable by the DP 10A/20A/40A of the RNC 10/20 and CN 40 and by the DP 30A of the UE 30, or by hardware, or by a combination of software and hardware. In some embodiments, a software aspect is implemented in both the CNs 40 and 40′, where the other CN 40′ is substantially the same as shown in FIG. 1 for the CN 40.

The various embodiments of the UE 30 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 15B, 20B, 25B, 30B and 40B may be of any type suitable to the local technical environment and may be implemented using any suitable data storage technology, such as semiconductor-based memory devices, magnetic memory devices and systems, optical memory devices and systems, fixed memory and removable memory. The DPs 10A, 15A, 20A, 25A, 30A and 40A may be of any type suitable to the local technical environment, and may include one or more of general purpose computers, special purpose computers, microprocessors, digital signal processors (DSPs) and processors based on a multi-core processor architecture, as non-limiting examples.

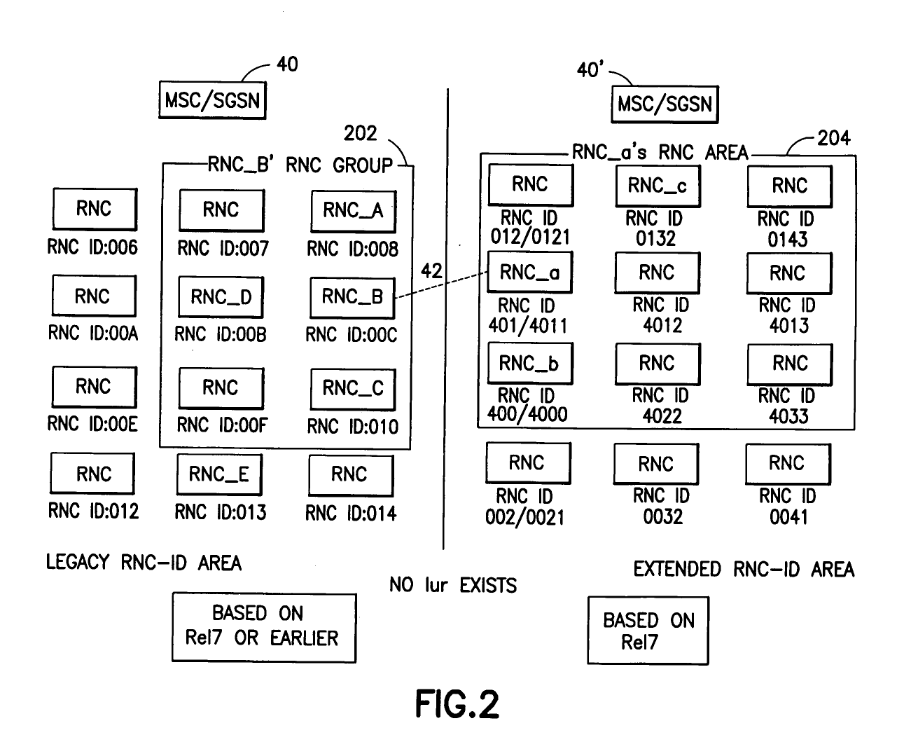

Now are described the particular embodiments of the invention, which is divided into three main implementations. An important distinction of these implementations over the known art is that those RNCs using one RNC-ID format, which are disposed in the network adjacent to an RNC using another RNC-ID format, use an identification/signaling regimen different than other RNCs in the network that are adjacent to only RNCs using the same RNC-ID format. It is convenient to group these RNCs into legacy groups 202 and extended groups 204 to reflect the RNC-ID format of the group members, as seen in FIG. 2. Whereas FIG. 2 shows two instances of a CN 40 & 40′ each coupled to a different group 202, 204, it is understood that there may be only one CN to which each and every depicted RNC has an Iu interface. While in practice it is predicted that RNCs with extended RNC-IDs will be geographically clustered in groups of two, three or more, a particular legacy RNC group 202 and/or extended RNC group 204 may have only one RNC member, as when all RNCs adjacent to a particular RNC use a format for their RNC-ID different than that used by the particular RNC. Of particular interest are those RNCs at the border of different-format groups, which are termed herein border RNCs. A border RNC then has two characteristics; it has a RNC-ID of the format according to its group (twelve or sixteen bits) and it is adjacent to an RNC that is a member of an opposite group (legacy or extended).

First Implementation: Configure the network 9 such that no Iur 42 exists between a legacy RNC group 202 and an extended RNC group 204 whose extended RNC-ID numbers are higher than 4096. I.e., there is no Iur between a border legacy RNC and a border extended RNC except under the conditions that the border extended RNC has an extended RNC-ID less than or equal to 4096. This is seen as particularly simple to adopt in that existing legacy RNCs need no change to their current procedures when adjacent to an extended RNC. The network assigns the RNC-ID numbers as above based on the disposition of RNCs relative to one another, and using the exception need sacrifice only a few of the 65,636 unique numbers, depending upon how many Iur interfaces are foregone that might otherwise be used.

In general for this first implementation, the network is configured such that, for the case where two border RNCs use different format RNC-IDs, the RNC-ID of a border RNC using one format is selected so as to read identically in the other format, and messages between those border RNCs for effecting a UE handover go through a CN 40 and 40′.

Second Implementation: Allocate two RNC-IDs, one a legacy RNC-ID and the other an extended RNC-ID, to the border extended RNCs and configure/set the first 12 bits of the extended RNC-ID to be the same as the legacy RNC-ID. In this implementation, the CN 40′ having an Iu to the (dual-ID) border extended RNC must have the information that two RNC-IDs are allocated to that same RNC, as well as to know both of the RNC-IDs allocated to that RNC.

As can be seen, in general the second implementation also uses a specific selection of RNC-IDs by the network to solve the problem, but in this implementation the extended border RNCs each carry two RNC-IDs, one of each type, and are selected so as to be identical at least in one format (the legacy bit string, since only the common most significant bits are used in one of the messages). However, as is seen in the example above there is no need to forego an Iur interface between the dual-ID extended RNC and its legacy RNC neighbors, so the UL SIGNALLING TRANSFER INDICATION and COMMON TRANSPORT CHANNEL RESOURCE REQUEST messages can not be exchanged directly between RNCs.

Third Implementation (first variation): Configure the RNC group such that the border legacy RNC can have an Iur connection and RNC group such that its neighboring extended RNC can have an Iur connection. But, avoid the case where a legacy RNC's twelve-bit RNC-ID is also the first twelve bits of an extended RNC-ID of the extended group (i.e., for the case where legacy RNC-ID=00C is used within the Legacy RNC group, then extended RNC-ID=00Cx will not be used within the extended group.).

Third Implementation (second variation): Alternatively, where the network uses both legacy and extended RNC-IDs, the first bit of every RNC-ID can be used to indicate the length of the RNC-ID. For example, a first bit=0 of any RNC-ID can be used to indicate that it is a legacy ID, and a first bit=1 of any RNC-ID can be used to indicate that it is an extended ID. While this removes one bit from the universe of unique identifiers available, once a network is completely switched so that all of its RNCs use an extended bit RNC-ID, there would no longer be a need to dedicate that first bit to identify ID bit-length, so as then network upgrades the entire sixteen bits will become available to it. Of course, the first bit is only a convenient location; any predetermined bit within the bit length of the shorter format (e.g., twelve) can be designated as a bit-length indicator.

Third Implementation (third variation): In this variation, the border legacy RNCs and the border extended RNCs always execute RRC Connection Re-establishment at an inter-RNC Cell Update to the cell in the RNC which it has a neighboring cell under a neighboring border RNC in a different RNC-ID area.

It is particularly noted that any of the above implementations can be used to overcome any difference in bit length among RNC-IDs, not only the twelve-to-sixteen difference used above in the examples. It will further be appreciated that some of the above implementations can be used to enable interoperability among RNCs that use different formats of their RNC-ID, even apart from bit-length.

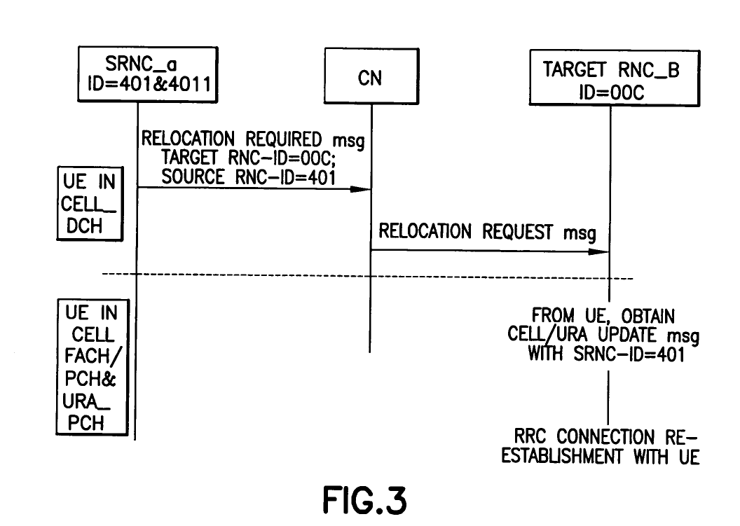

Examples: In the signaling diagrams of FIGS. 3-8, a horizontal dashed line separates different scenarios, which are indicated by the UE channel at the left of those diagrams. Consider as a first example of an embodiment of the invention that the current SRNC is RNC-a (RNC-ID 401) of FIG. 2 and the UE 30 moves to a cell under control of RNC-B (RNC-ID 00C). This is shown in the signaling diagram of FIG. 3, and illustrates both the first and second implementations, as it does not use an Iur interface between the RNCs and the SRNC uses a legacy RNC-ID for this handover (though it may use its extended RNC-ID when coordinating with other RNCs that use an extended RNC-ID). For a hard handover HHO relocation (when the UE is on the DCH of the cell), RNC-a sends to the CN 40′ a RELOCATION REQUIRED message, with the target RNC-ID set to 00C and the source ID set to 401. The CN 40 sends a RELOCATION REQUEST message to RNC-B, which is the proper target RNC since there is no conflict with the RNC-ID format. The current SRNC (RNC-a) executes the remainder of relocation procedures as normal.

For Radio Resource Control RRC re-establishment (when the UE is on the FACH or PCH of the cell and also the PCH of the URA), RNC-B receives from one of its cells (NodeB's) a cell or URA (UE registration area) update that originated from the UE 30 being transferred. Events requiring the UE to send a cell update are defined in 3GPP TS 25.331, section 8.3.1.2 (and 3GPP2 TS 25.331, section 8.3.1) and include radio link failure, re-entering a service area, RLC unrecoverable error, cell reselection and periodical cell update. In response to receipt of the CELL UPDATE or URA UPDATE message, the NodeB/RNC sends a CELL UPDATE CONFIRM message (or URA UPDATE CONFIRM message) to the UE, which may in turn require a response from the UE, for example a UTRAN MOBILITY INFORMATION CONFIRM message. Regardless of the UE's trigger to send it, the cell/URA Update message bears SNRC-ID=401 for RNC_a. But since the UE 30 is now within the area of RNC_B, then RNC_B executes RRC Connection Re-establishment procedures with the UE 30, and becomes the new SRNC.

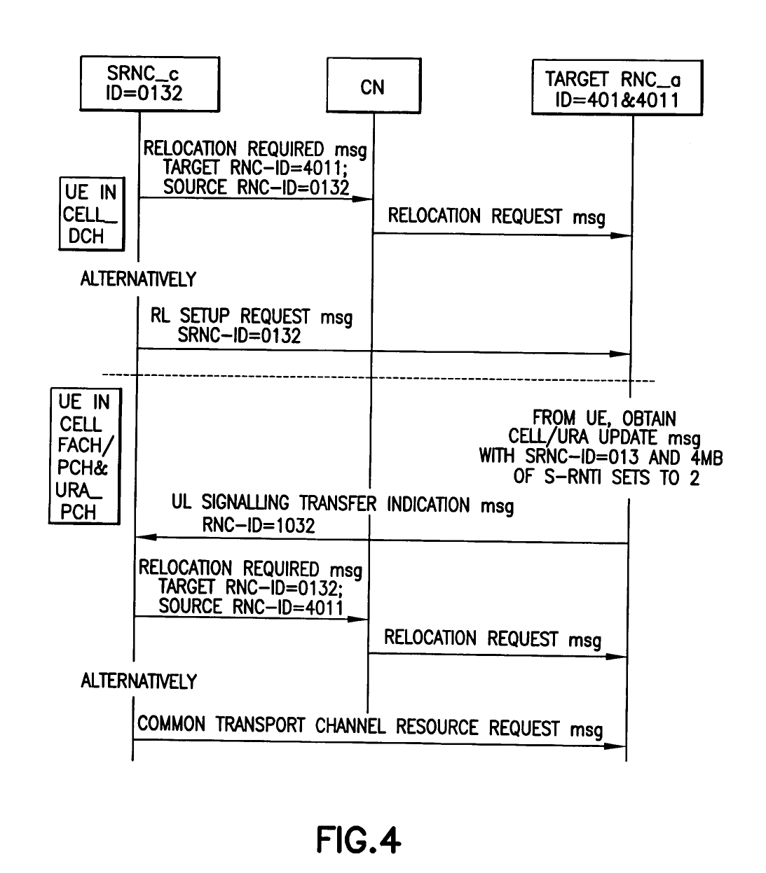

Consider as a second example of the invention that the current SRNC is RNC-c (RNC-ID 0132) of FIG. 2 and the UE 30 moves to a cell under control of RNC-a (RNC-ID 401/4011). Two situations are shown in the signaling diagram of FIG. 4 separated by the horizontal dotted line. The first situation of FIG. 4, above the dotted line, the UE 30 is in the Cell_DCH (dedicated channel). The SRNC, RNC-c, sends to the CN 40′ a RELOCATION REQUIRED message with the target RNC-ID set to 4011 and the source RNC-ID set to 0132. The CN 40′ sends to the target RNC_a a corresponding RELOCATION REQUEST message, and the RNC-a then follows normal relocation procedures. Alternatively, for anchoring, RNC_c sends to RNC_a over the Iur interface a radio link RL SETUP REQUEST message with the SRNC-ID set to 0132, and thereafter the RL setup procedures continue as normal.

The second situation of FIG. 4 is shown below the dotted line, when the UE 30 is in the Cell_FACH/PCH and URA_PCH (forward access channel FACH; paging channel PCH, and UTRAN registration area URA). In this situation, RNC_a receives a Cell/URA Update message from the UE (through the cell NodeB). That message identifies the UE's SRNC, in this example RNC-ID=0132. This message also carries the four most significant bits MSB of the serving radio node temporary identifier S-RNTI set to 2 (i.e. from U-RNTI). Since in this example there is an Iur between the two subject RNCs, then RNC-a forwards this Cell/URA Update message to RNC_c, identified from that message from the UE. RNC_a then sends to RNC_c an UPLINK SIGNALLING TRANSFER INDICATION message with the RNC-ID set to 4011.

Continuing with this same example, for relocation RNC_c sends to the CN 40′ a RELOCATION REQUIRED message with the target RNC-ID set to 4011 and the source RNC-ID set to 0132, all extended RNC-IDs. The CN 40′ sends to RNC-a a RELOCATION REQUEST message, and relocation procedures continue as normal after that. Alternatively, for anchoring, RNC_c sends to RNC_a a COMMON TRANSPORT CHANNEL RESOURCE REQUEST message, and otherwise normal changeover procedures are executed.

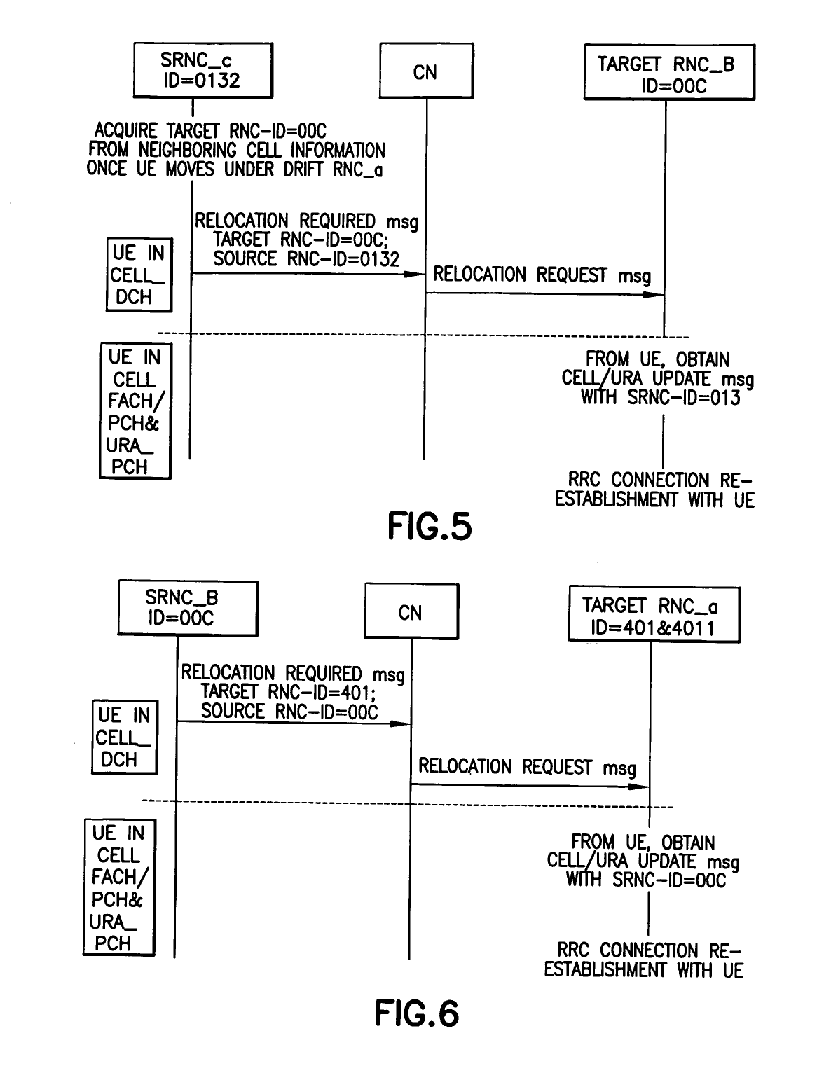

In a third example of the invention, consider the SRNC is RNC-c (extended), a drift RNC is RNC-a (dual-ID extended), and the UE 30 moves toward RNC-B (legacy). Signaling for this example is seen in FIG. 5. For a HHO relocation, RNC_c sends to the CN 40′ a RELOCATION REQUIRED message with the target RNC-ID set to 00C and the source RNC-ID set to 0132. (In this case, RNC_c acquired the target RNC-ID from neighboring cell information when the UE 30 moved under RNC_a.) The CN 40 then sends to RNC_B a RELOCATION REQUEST message, and RNC-c continues with the relocation as normal. For RRC Re-establishment, RNC_B receives a Cell/URA Update message with the hexadecimal SRNC-ID set to 0132, and RNC_B executes RRC Connection Re-establishment as normal.

In a fourth example shown in FIG. 6, consider RNC_B as the SRNC and the UE 30 moves to RNC_a as the target RNC. For HHO relocation, RNC_B sends to the CN 40 a RELOCATION REQUIRED message that has the target RNC-ID set to 401 and the source RNC-ID set to 00C. The CN 40′ then sends to RNC_a a RELOCATION REQUEST message, because the CN 40′ understands that both RNC-IDs (i.e., 401 and 4011) are allocated to RFNC-a. For RRC re-establishment, RNC_a receives the Cell/URA Update message with the hexadecimal SRNC-ID set to 00C, which RNC-a recognizes as the RNC-ID of RNC-B. RNC_a then executes RRC connection re-establishment procedures.

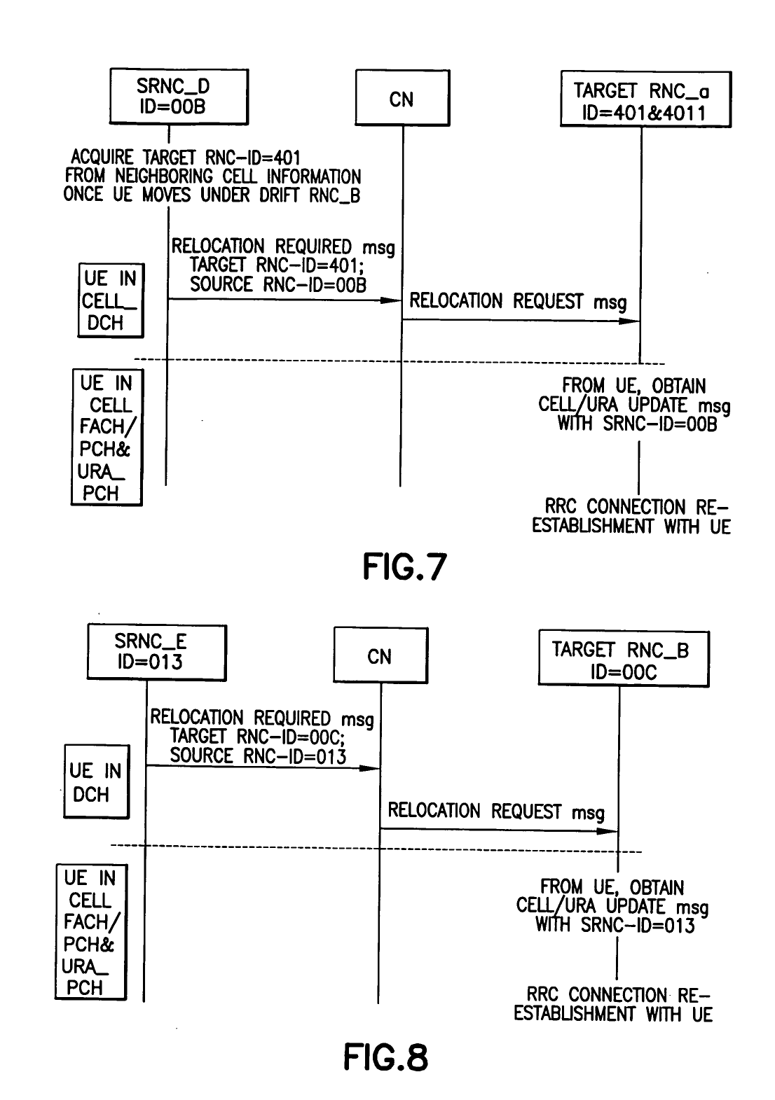

In a fifth example of the invention, shown in FIG. 7, consider that RNC_D is the SRNC, RNC_B serves as a drift RNC, and the UE 30 moves to control of a cell under RNC_a as target. For HHO relocation, serving RNC_D sends to the CN 40 a RELOCATION REQUIRED message with the target RNC-ID set to 401 and the source RNC-ID set to 00B. As in a previous example, the serving RNC (RNC_D) acquired the RNC-ID of the target by neighboring cell information when the UE 30 moved under the drift RNC (RNC_B). The CN 40′ then sends to the target RNC_a a RELOCATION REQUEST. For RRC connection re-establishment, RNC_a receives the Cell/URA Update message with the hexadecimal SRNC-ID set to 00B, which RNC_a recognizes as the RNC ID of an RNC with which RNC_a does not have an Iur. RNC_a then executes RRC connection re-establishment procedures.

In a sixth example of how the invention might be implemented, consider that the SRNC is RNC_E, the drift RNC is RNC_C and the UE 30 moves to RNC_B. This sixth example is shown in the signaling diagram of FIG. 8. Assume that RNC_B has an Iur interface with RNC_C, but does not have an Iur interface with RNC_E. For HHO Relocation, RNC_E sends to the CN 40 a RELOCATION REQUIRED message with the target RNC-ID set to 00C and the source RNC-ID set to 013. The CN 40 sends to RNC_B a RELOCATION REQUEST message, and then RNC_E continues as normal for relocation of the UE 30. For RRC re-establishment, target RNC_B receives the Cell/URA Update message with the SRNC-ID set to 013 which RNC_B recognizes as the RNC ID of an RNC with which RNC_B does not have Iur. RNC_B then executes RRC connection re-establishment procedures.

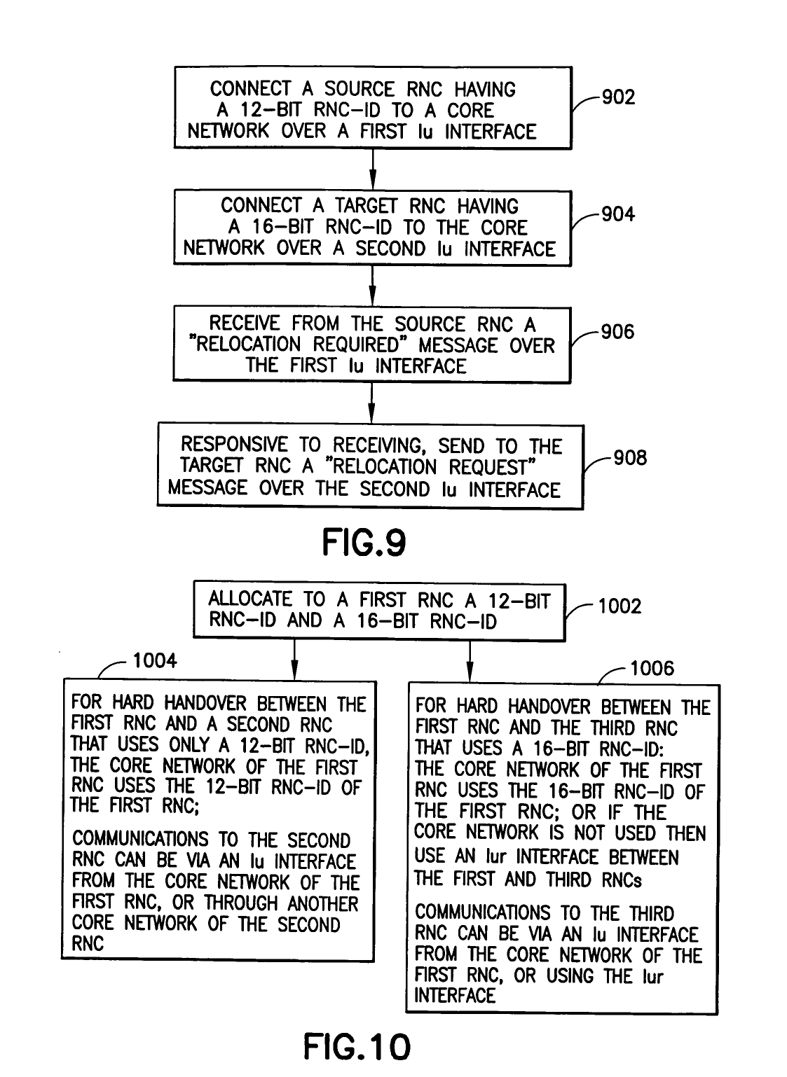

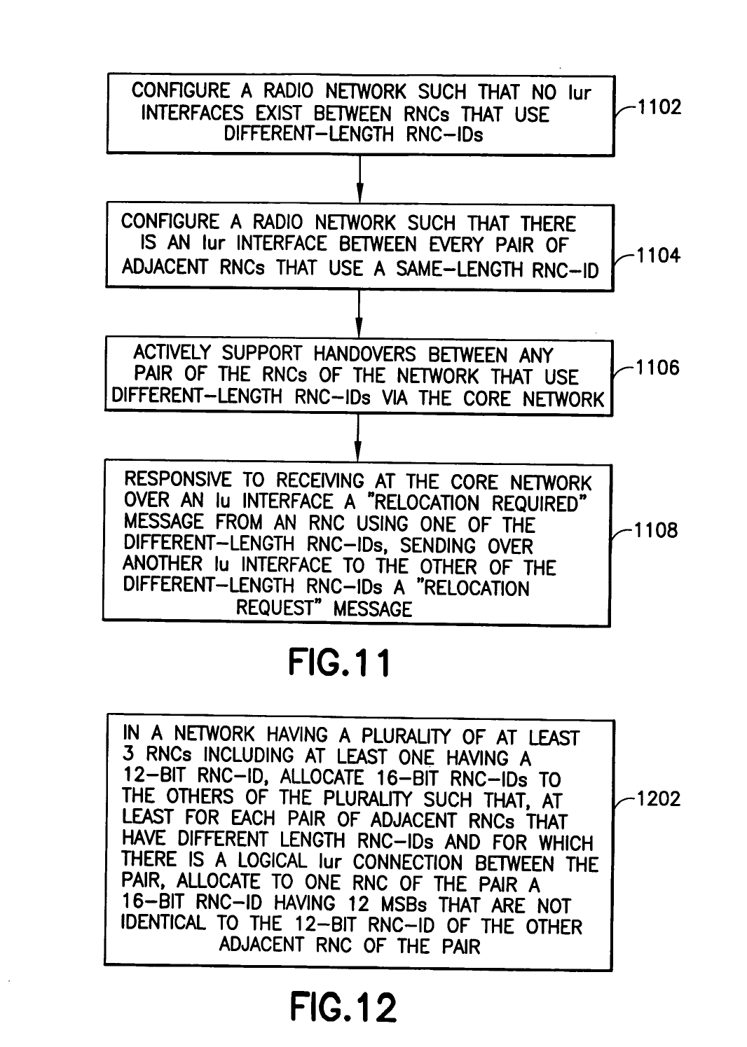

Based on the foregoing it should be apparent that the exemplary embodiments of this invention provide in one embodiment a method, apparatus and computer program product(s) to enable interoperability among radio network controllers by configuring the network such that no logical interfaces Iurs exist between RNCs that use a different RNC-ID format. In an embodiment, messages to effect a UE handover from an RNC using an identifier of a first format to another RNC using an identifier of a second format go through an intermediary (e.g., the core network). The network may be configured such that for all adjacent RNCs, only those adjacent RNCs that use different format identifiers lack an Iur between them, and further that every handover between those adjacent but different ID format RNCs go through the intermediary. A logical interface Iur would still exist between RNCs in the network using the same RNC-ID format. These are shown at FIGS. 9 and 11.

FIG. 9 illustrates at block 902 that a source RNC having a 12-bit RNC-ID is connected to a core network over a first Iu interface, and at block 904 that a target RNC having a 16-bit RNC-ID is connected to the core network over a second Iu interface. At block 906 the core network receives from the source RNC over the first Iu interface a RELOCATION REQUIRED message that identifies the target RNC, and responsive to block 906, at block 908 the core network sends to the target RNC a RELOCATION REQUEST message over the second Iu interface.

FIG. 11 illustrates at block 1102 that a radio network is configured such that no Iur interfaces exist between RNCs that use different length RNC-IDs. At block 1104 the radio network is configured such that an Iur interface exists between every pair of adjacent RNCs that use a same-length RNC-ID. At block 1106, the core network actively supports hard handovers, of which an example is shown at block 1108 where the core network receives a RELOCATION REQUIRED message from one of the pair from block 1106 and sends a RELOCATION REQUEST to the other of the pair.

Based on the foregoing it should be apparent that the exemplary embodiments of this invention provide in another embodiment a method, apparatus and computer program product(s) to enable interoperability among radio network controllers by allocating to certain RNCs an identifier of a first format and an identifier of a second format. Specifically, those RNCs that are adjacent to an RNC using only the older first format are allocated dual RNC-IDs, one of each format. When the dual-ID RNC communicates over an interface Iu with the RNC using only the older first format, the dual-ID RNC uses its older first format ID, and when communicating over an interface Iur with another RNC that uses the second format (whether or not that another RNC also carries dual IDs), the dual-ID RNC uses its second format ID. This is shown at FIG. 10, where at block 1002 there is allocated to a first RNC a 12-bit RNC-ID and a 16-bit RNC-ID. For the case at block 1004 of hard handovers or any other relocation between the first RNC and another (second) RNC that uses only a 12-bit RNC-ID but not also a 16-bit RNC-ID, the core network of the first RNC uses the 16-bit RNC-ID of the first RNC. Communications for this handover can go from the core network directly to the second RNC via an Iu interface, or they may go from the said core network (that has the Iu interface with the first RNC) through another core network that has an Iu interface with the second RNC. For the other case at block 1006 of hard handovers or any other relocation between the first RNC and a third RNC that uses a 16-bit RNC-ID (and which may use a 12-bit RNC-ID additionally, just like the first RNC), either the core network of the first RNC uses the 16-bit RNC-ID of the first and of the second RNC or the first and second RNC handle the handover via a direct Iur interface between them.

Based on the foregoing it should be apparent that the exemplary embodiments of this invention provide in still another embodiment a method, apparatus and computer program product(s) to enable interoperability among radio network controllers by allocating RNC-IDs such that, for any pair of adjacent RNCs that use RNC-IDs of different bit lengths, the twelve most significant bits of the longer bit length are selected so as not to repeat the RNC-ID of the adjacent RNC that uses the shorter bit length. This is shown at FIG. 12, where at block 1202 a network that has a plurality of at least 3 RNCs including at least one having a 12-bit RNC-ID [e.g., it may have been allocated in some time past], there is allocated 16-bit RNC-IDs to the others of the plurality (e.g., those upgraded RNCs) such that, at least for each pair of adjacent RNCs that have different length RNC-IDs AND for which there is a logical Iur connection between the pair, allocate to one RNC of the pair a 16-bit RNC-ID having 12 MSBs that are not identical to the 12-bit RNC-ID of the other adjacent RNC of the pair.

Based on the foregoing it should be apparent that the exemplary embodiments of this invention provide in another embodiment a method, apparatus and computer program product(s) to indicate within an RNC-ID a format of that RNC-ID, such as using the first bit of the RNC-ID to indicate the bit length of the RNC-ID. Similarly, entities reading a message with an RNC-ID will recognize that bit as the indicator, and selectively treat the RNC-ID of the message as being one format or the other based on the value of the bit/indicator.

Based on the foregoing it should be apparent that the exemplary embodiments of this invention provide in yet another embodiment a method, apparatus and computer program product(s) to provide that a border RNC, using either the first RNC-ID format (legacy) or the second RNC-ID format (extended), always execute RRC Connection Re-establishment at an inter-RNC Cell Update to the cell in the RNC which it has a neighboring cell under a neighboring border RNC in a different RNC-ID area.

Note that the various message flows described may be viewed as method steps and/or as operations that result from operation of computer program code. Certain of the above embodiments/implementations can be combined with one another.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, message flow diagrams, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
configuring a radio network such that there is no direct interface between any controller element of the radio network that recognizes only shorter length identifiers for controller elements and any controller element of the radio network that uses a longer length identifier; and
for the case where one controller element of a pair recognizes only the shorter length identifiers and another controller element of the pair uses the longer length identifier, supporting relocation between the pair of the controller elements through a core network.

2. The method of claim 1, wherein the controller elements are radio network controllers, the shorter length identifiers are twelve bits and the longer length identifiers are sixteen bits.

3. The method of claim 1, further comprising configuring the radio network such that there is a direct Iur interface between each pair of adjacent controller elements that use a same length identifier.

4. The method of claim 1, wherein supporting relocation between the pair of the controller elements through the core network comprises receiving at the core network from the other of the pair a relocation required message that includes the identifier of the one of the pair and in response sending from the core network to the one of the pair a relocation request message.

5. The method of claim 1, wherein configuring the radio network comprises configuring such that there is no direct interface between any controller element of the radio network that uses one of the shorter length identifiers and any controller element of the radio network that uses one of the longer length identifiers.

6. A computer readable memory embodying a program of machine-readable instructions executable by a digital data processor to perform actions directed toward supporting relocation of a user equipment, the actions comprising:
configuring a radio network such that there is no direct interface between any controller element of the radio network that recognizes only shorter length identifiers for controller elements and any controller element of the radio network that uses a longer length identifier; and
for the case where one controller element of a pair recognizes only the shorter length identifiers and another controller element of the pair uses the longer length identifier, supporting relocation between the pair of the controller elements through a core network.

7. The memory of claim 6, further comprising configuring the radio network such that there is a direct Iur interface between each pair of adjacent controller elements that use a same length identifier.

8. The memory of claim 6, wherein supporting relocation between the pair of the controller elements that use the different length identifiers through the core network comprises receiving at the core network from one of the pair a relocation required message that includes the identifier of the other of the pair and in response sending from the core network to the other of the pair a relocation request message.

9. A system comprising:
a plurality of at least three radio network controller elements each having an identifier having a length and configured with respect to one another such that:
there is no direct interface between any pair of the radio network controller elements for which one controller element of the pair recognizes only shorter length identifiers for controller elements and another controller element of the pair uses a longer length identifier;
a direct interface exists between each pair of radio network controller elements that are adjacent to one another and that use a same length identifier; and
a direct interface exists between each of the radio network controller elements and a core network.

10. The system of claim 9, wherein the direct interface between each pair of radio network controller elements that are adjacent to one another and that use a same length identifier is an Iur interface; and
the direct interface between each of the radio controller elements and the core network is an Iu interface.

11. The system of claim 9; the system further configured to support relocation between any pair of the controller elements for which one controller element of the pair recognizes only the shorter length identifiers and another controller element of the pair uses the longer length identifier through the core network and Iu interfaces but not through any Iur interface, and to support relocation between any pair of the controller elements that use the same length identifiers through the Iur interface that runs between said pair of the controller elements that use the same length identifier.

12. The system of claim 9, wherein the system is configured to support relocation between any pair of the controller elements for which one controller element of the pair uses the shorter length identifier and another controller element of the pair uses the longer length identifier by receiving at the core network from one of the any pair a relocation required message that includes the identifier of the other of the any pair and in response sending from the core network to the other of the any pair a relocation request message.

13. The system of claim 9 wherein the shorter length identifiers are twelve bits each and the longer length identifier is sixteen bits.

14. The system of claim 9, wherein no direct interface is configured between any pair of the radio network controller elements for which one controller element of the pair uses the shorter length identifier and another controller element of the pair uses the longer length identifier.

15. A method comprising:
allocating identifiers to controllers of radio networks such that, for any pair of adjacent controllers having identifiers of different bit lengths and a direct connection between them, the most significant bits of the longer bit length identifier do not repeat the shorter bit length identifier; and
supporting relocation between a particular pair of the adjacent controllers using the identifiers of different bit lengths.

16. The method of claim 15, wherein all of the allocated identifiers are either the shorter bit length or the longer bit length.

17. The method of claim 16, wherein the controllers of radio networks are radio network controllers RNCs of a core network each having a direct Iu interface to the core network, the allocated identifiers are RNC-IDs, and wherein the allocating is among all of the RNCs of the core network and there are at least three RNCs.

18. The method of claim 16, wherein the shorter bit length is twelve bits and the longer bit length is sixteen bits.

19. The method of claim 15, wherein the direct connection is a direct Iur connection.

20. The method of claim 19, further wherein different bit length identifiers are allocated among pairs of adjacent controllers that do have a direct Iur connection between them without regard to the most significant bits of longer bit length identifier repeating the shorter bit length identifier.

21. The method of claim 15, wherein the shorter bit identifiers are allocated at a past time and the longer bit length identifiers are allocated at a later time such that for any of the said pairs the most significant bits of the longer bit length identifier are not the same as the shorter bit length identifier.

22. The method of claim 15, wherein supporting relocation comprises receiving a relocation required message from a source controller of the particular pair and in response sending a relocation request message to a target controller of the particular pair.

23. The method of claim 15, wherein the allocating identifiers to the controllers of radio networks comprises:
allocating to at least one controller of a first group of adjacent controllers a twelve bit identifier;
allocating to at least one controller of a second group of adjacent controllers a sixteen bit identifier,
wherein the first group is adjacent to the second group, and wherein none of the twelve bit identifiers allocated to controllers of the first group repeat the twelve most significant bits of any of the sixteen bit identifiers allocated to the second group of controllers.

24. A computer readable memory embodying a program of machine-readable instructions executable by a digital data processor to perform actions directed toward allocating different length identifiers, the actions comprising allocating identifiers to controllers of radio networks such that, for any pair of adjacent controllers having identifiers of different bit lengths and a direct connection between them, the most significant bits of the longer bit length identifier do not repeat the shorter bit length identifier.

25. The computer readable memory of claim 24, the actions further comprising supporting relocation between a particular pair of the controllers using the identifiers of different bit lengths.

26. The computer readable memory of claim 24, wherein all of the allocated identifiers are either the shorter bit length which is twelve bits or the longer bit length which is sixteen bits, the controllers of radio networks are radio network controllers RNCs of a core network each having a direct Iu interface with the core network, the allocated identifiers are RNC-IDs, wherein the allocating is among all of the RNCs of the core network and there are at least three RNCs in the core network, and wherein the direct connection is a direct Iur connection.

27. A system comprising:
a plurality of radio network controllers each having an assigned identifier having a length for use in relocation procedures, the radio network controllers configured such that there is a direct connection between some pairs of adjacent radio network controllers and there is no direct connection between other pairs of adjacent radio network controllers,
wherein for each of the other pairs of adjacent radio network controllers that also have different bit length identifiers assigned, the most significant bits of the longer bit length identifier of the pair does not repeat the shorter bit length identifier of the pair.

28. The system of claim 27, wherein each of the assigned identifiers are either the shorter bit length or the longer bit length.

29. The system of claim 28, wherein the plurality of radio network controllers comprise all radio network controllers of a core network and each RNC has a logical Iu interface to the core network, and the assigned identifiers are RNC-IDs.

30. The system of claim 28, wherein the shorter bit length is twelve bits and the longer bit length is sixteen bits.

31. The system of claim 27, wherein the direct connection is an Iur connection.

32. The system of claim 27, wherein at least one controller of a first group of adjacent ones of the radio network controllers has a twelve bit identifier assigned, and at least one controller of a second group of adjacent ones of the radio network controllers has a sixteen bit identifier assigned and the second group is adjacent to the first group, and wherein none of the twelve bit identifiers allocated to the radio network controllers of the first group repeat the twelve most significant bits of any of the sixteen bit identifiers allocated to the radio network controllers of the second group.

33. An apparatus comprising a processor and a memory configured to:
allocate identifiers to controllers of radio networks such that, for any pair of controllers having identifiers of different bit lengths and a direct connection between them, the most significant bits of the longer bit length identifier do not repeat the shorter bit length identifier, and
to support relocation between a particular pair of the adjacent controllers using the identifiers of different bit lengths.

34. The apparatus of claim 33, wherein all of the allocated identifiers are either the shorter bit length or the longer bit length.

35. The apparatus of claim 34, wherein the controllers of radio networks are radio network controllers RNCs of a core network and each RNC has a direct Iu interface to the apparatus, the allocated identifiers are RNC-IDs, and wherein the identifiers are allocated among all of the RNCs of the core network and there are at least three RNCs in the RAN.

36. The apparatus of claim 34, wherein the shorter bit length is twelve bits and the longer bit length is sixteen bits.

37. The apparatus of claim 33, wherein the direct connection is an Iur connection.

38. The apparatus of claim 33, wherein the apparatus comprises a network element of a core network, and supports relocation by receiving a relocation required message from a source controller of the particular pair and in response sending a relocation request message to a target controller of the particular pair.

39. The apparatus of claim 33, wherein the processor and memory are configured to allocate identifiers to the controllers such that at least one controller of a first group of adjacent ones of the controllers has a twelve bit identifier allocated, and at least one controller of a second group of adjacent ones of the controllers has a sixteen bit identifier allocated and the second group is adjacent to the first group, and wherein none of the twelve bit identifiers allocated to the controllers of the first group repeat the twelve most significant bits of any of the sixteen bit identifiers allocated to the controllers of the second group.

40. An apparatus comprising:
processing means for allocating identifiers to controllers of radio networks such that, for any pair of controllers having identifiers of different bit lengths and a direct connection between them, the most significant bits of the longer bit length identifier does not repeat the shorter bit length identifier; and
storing means for storing in a local memory the allocated identifiers.
